(19) United States
(12) Patent Application Publication
(10) Pub. No.: US 2008/0111342 A1
(43) Pub. Date: May 15, 2008

(54) Bicycle having an antilock brake

(75) Inventors: Johannes Van Niekerk, Mountain View, CA (US); Philip Schlesinger, Munchen (DE)

Correspondence Address: MANFRED BECK, P.A., 830 TYLER STREET, HOLLYWOOD, FL, 33019-1327, US

(73) Assignees: Volkswagen of America, Inc., Auburn Hills, MI (US); Audi AG, Ingolstadt (DE)

(21) Appl. No.: 11/595,111

(22) Filed: Nov. 9, 2006

(51) Int. Cl. B62L 1/02; B62M 1/02

(52) U.S. Cl. 280/261; 188/26

(57) ABSTRACT

A bicycle includes an electric motor for driving a hydraulic actuator for a brake caliper of a brake disc of the front wheel of the bicycle. An electronic control unit receives wheel speed information from a wheel speed sensor, input pressure information from an input pressure sensor connected to a brake lever, and hydraulic pressure information from a hydraulic pressure sensor, which measures the hydraulic pressure for the brake caliper. The electronic control unit controls the hydraulic actuator based on the wheel speed information, the input pressure information from the input pressure sensor, and the hydraulic pressure information from the hydraulic pressure sensor such that the hydraulic pressure for the brake caliper is adjusted to prevent the bicycle front wheel from locking up when input pressure is provided via the brake lever.

### BACKGROUND OF THE INVENTION

### Field of the Invention

The invention relates to bicycle having an antilock brake system.

A mechanical concept for an antilock brake system for a bicycle is disclosed in U.S. Pat. No. 6,786,308 B1. The antilock brake system includes a brake shoe holder, a sliding assembly, a brake shoe and a spring. The brake shoe holder has a recess at a side facing toward the wheel rim of the bicycle. A slope is formed at a bottom of the recess of the brake shoe holder such that the slope slants outward in a forward rotating direction of the tire of the bicycle. The sliding assembly is received in the recess of the brake shoe holder and the brake shoe is received in the sliding assembly. A slope is formed at the bottom of the sliding assembly such that the slope slants outward in the forward rotating direction of the tire of the bicycle corresponding to the slope of the brake shoe holder. The spring is accommodated in the recess of the brake shoe holder such that one end of the spring abuts against the brake shoe holder and the other end of the spring abuts against the sliding assembly.

The above-described mechanical concept is based on the general idea that a de-energized brake will prevent the wheel from locking up during braking. However, a disadvantage of these mechanical concepts is that, when the brake is de-energized, the brake will feel sluggish. A further disadvantage of the mechanical concepts for antilock brakes is that they are prone to malfunction when mechanical parts that slide against one another are exposed to water, dirt or dust.

An electronically controlled antilock brake system for bicycles is disclosed in German Patent Application Publication No. DE 195 08 915 A1. The antilock brake system includes a hydraulic brake that acts on the front wheel of the bicycle. The pressure for the hydraulic brake is generated by a hand-operated or foot-operated hydraulic cylinder. The pressure for the hydraulic brake is limited or reduced by a pressure control device in case there is a danger of a wheel lockup on a slippery surface or in case the rear wheel of the bicycle lifts off the ground. The pressure control device is actuated by an electronic control unit which receives sensor signals for monitoring the wheels and controls the pressure for the brake in order to prevent the front wheel from sliding and the rear wheel from lifting off the ground.

Since the bicycle has no power source for a pump that would return hydraulic fluid to the hand-operated or foot-operated hydraulic cylinder, the antilock brake system disclosed in German Patent Application Publication No. DE 195 08 915 A1 is configured to operate without such a pump. As a consequence, the travel distance for the hand or foot lever can increase when the antilock control is active for an extended period. A disadvantage of the antilock brake system disclosed in German Patent Application Publication No. DE 195 08 915 A1 is that the function of the brake may be impaired when the hand and or foot lever is at its maximum travel and abuts against a stop. For example, the function of the brake may be impaired when the hand lever of the brake pivots so far that it touches the handlebar.

German Patent Application Publication No. DE 101 58 32 A1 discloses another antilock brake system for a bicycle. The antilock brake system includes a sensor for detecting a wheel speed, an electronic control device and a hydraulic actuating device. The hydraulic actuating device includes a master cylinder, a cut-off valve, an outlet valve with a parallel-connected return valve, a low-pressure reservoir for hydraulic fluid, a slave cylinder and an electric contact configuration for interrupting the antilock control when the hand brake lever is about to touch the handlebar. A disadvantage of the antilock brake system disclosed in German Patent Application Publication No. DE 101 58 32 A1 is that the antilock control can be maintained only for a limited number of antilock control cycles before the electric contact configuration senses a maximum travel for the hand brake and interrupts the antilock control operation. As a result of the limited number of antilock control cycles, the antilock brake can only be used for rim brakes. Disk brakes and drum brakes generate a brake torque that is three to six times smaller than the brake torque of rim brakes because the friction radius of disk brakes and drum brakes is smaller than the friction radius of rim brakes. In order to generate a required brake torque for a disk brake or a drum brake, it would be necessary to increase the travel path of the brake lever which in turn would reduce the reserves of the antilock brake, i.e. the possible number of antilock control cycles, to an unacceptable level.

German Patent Application Publication No. DE 42 00 440 A1 discloses a method for controlling a braking force for a motorcycle. Wheel speeds are detected by sensors and are evaluated by a microprocessor. The microprocessor controls a pressure modulator in order to prevent a wheel lock-up. In order to permit a comfortable braking behavior with optimum vehicle deceleration, it is proposed that the vehicle deceleration value which has been measured when a rear wheel lift-off signal has occurred is considered as a vehicle load-specific optimum deceleration point and is stored as deceleration limit value. A disadvantage of the antilock brake system disclosed in German Patent Application Publication No. DE 42 00 440 A1 is that it requires a considerable hardware outlay for a double-channel antilock braking system. The resulting weight of the braking system and the especially the power needed to operate the antilock braking system make it unsuitable for an application in bicycles.

### SUMMARY OF THE INVENTION

It is accordingly an object of the invention to provide a bicycle with an antilock brake system which overcomes the above-mentioned disadvantages of the heretofore-known bicycles of this general type and which operates reliably, has a low power consumption, is light-weight and can be implemented in a cost-effective manner.

With the foregoing and other objects in view there is provided, in accordance with the invention, a bicycle including:

a bicycle front wheel;

a brake disc connected to the bicycle front wheel;

a brake caliper configured to exert pressure on the brake disc;

a hydraulic actuator connected to the brake caliper and configured to provide a hydraulic pressure for the brake caliper;

an electric motor operatively connected to the hydraulic actuator and configured to drive the hydraulic actuator;

a power supply connected to the electric motor for providing electric power to the electric motor;

a wheel speed sensor configured to detect a rotational wheel speed;

a brake lever configured to provide an input pressure;

an input pressure sensor operatively connected to the brake lever and configured to measure the input pressure provided by the brake lever;

a hydraulic pressure sensor configured to measure the hydraulic pressure for the brake caliper;

an electronic control unit operatively connected to the input pressure sensor, the wheel speed sensor, the hydraulic pressure sensor and the electric motor;

the electronic control unit being configured to receive rotational wheel speed information from the wheel speed sensor, input pressure information from the input pressure sensor, and hydraulic pressure information from the hydraulic pressure sensor; and

the electronic control unit controlling the hydraulic actuator based on the rotational wheel speed information from the wheel speed sensor, the input pressure information from the input pressure sensor, and the hydraulic pressure information from the hydraulic pressure sensor, and the electronic control unit controlling the hydraulic actuator such that the hydraulic pressure for the brake caliper is adjusted to prevent the bicycle front wheel from locking up when input pressure is provided via the brake lever.

According to another feature of the invention, the wheel speed sensor is a sensor element that is embodied as a Hall sensor or as an optical gate sensor.

According to yet another feature of the invention, the wheel speed sensor includes multiple sensors configured such that a measurement frequency is increased in comparison to a wheel speed sensor including a single sensor. Multiple sensors are advantageous in case an increased frequency for the measurement is desired. An advantage of multiple sensors is also that the reliability of the measurement can be improved, in particular in the case of the failure of an individual sensor.

According to another feature of the invention, the brake disc has a perimeter and has tabs disposed at substantially equal distances from one another along the perimeter of the brake disc; and the wheel speed sensor is an optical gate sensor defining an optical beam path, the wheel speed sensor is disposed at the perimeter of the brake disc such that the tabs move into and out of the optical beam path when the brake disc rotates. This configuration is advantageous because a regular bicycle brake disc can be easily adapted for use with the brake system according to the invention.

According to a further feature of the invention, the tabs are substantially rectangular teeth disposed along the perimeter of the brake disc.

According to another feature of the invention, a gearbox is connected to the electric motor; and a mechanical linkage connects the gearbox to the hydraulic actuator such that the electric motor drives the hydraulic actuator via the gearbox and the mechanical linkage. An advantage of using a gearbox and a mechanical linkage is that commercially available electric motors, gearboxes, linkage elements, and bicycle brake master cylinders can be used and easily adapted for a variety of types of bicycles.

According to yet another feature of the invention, the electric motor has a given motor power rating; and the power supply is a battery with a given battery power rating such that the battery is capable of powering the electric motor during normal operation. An advantage of powering the electric motor with a battery is that the power for the operation of the brake system need not be generated by the rider via a generator. The battery power rating is preferably such that the battery has sufficient power for operating the bicycle at least for several hours under normal operating conditions.

According to another feature of the invention, the electronic control unit includes a wheel speed and caliper pressure circuit and an antilock brake system controller circuit; the wheel speed and caliper pressure circuit includes a microcontroller and a controller area network transceiver for transferring signals between the microcontroller and the wheel speed sensor and the hydraulic pressure sensor; and the antilock brake system controller circuit includes a microcontroller, a motor drive circuit and a controller area network transceiver for transferring signals between the microcontroller and the input pressure senor and the motor drive circuit. An advantage of having a wheel speed and caliper pressure circuit and an antilock brake system controller circuit is that these two circuits can be implemented on two separate circuit boards as separate modules which can be mounted in two different locations on the bicycle. An advantage of using microcontrollers in combination with controller area network transceivers is that commercially available low-cost components that are designed to work together can be used.

According to another feature of the invention, the bicycle includes a bicycle rear wheel, a rear brake disc connected to the bicycle rear wheel, a rear brake caliper configured to exert pressure on the rear brake disc, and a rear brake lever configured to provide a brake pressure for the rear brake caliper. An advantage of having an ABS controlled front disc brake in combination with a conventional disc brake for the rear wheel (rather than an ABS controlled brake) is that such a system provides a good braking performance while at the same time the complexity and correspondingly the costs for the brake system are reduced.

According to yet another feature of the invention, the electronic control unit controls the hydraulic actuator without any wheel speed information related to the bicycle rear wheel. As a result, no wheel speed sensor is needed for the rear wheel of the bicycle and thus cost and complexity of the system are reduced.

Other features which are considered as characteristic for the invention are set forth in the appended claims.

Although the invention is illustrated and described herein as embodied in a bicycle having an antilock brake, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of a bicycle having an antilock brake system according to the invention;

FIG. 2 is a partial diagrammatic side view of an exemplary embodiment of a brake disc for an antilock brake system according to the invention;

FIG. 3 is a diagrammatic perspective view of an optical gate sensor for measuring a rotational speed of a wheel of a bicycle according to the invention;

FIG. 4 is a schematic block diagram illustrating the main components of the electronic control unit and components connected to the electronic control unit in accordance with the invention;

FIG. 5 is a state flow diagram illustrating the method of an antilock brake control in accordance with the invention;

FIG. 6 is a state flow diagram illustrating the operation of the wheel speed and caliper pressure circuit according to the invention; and

FIG. 7 is a state flow diagram illustrating the operation of the main ABS controller circuit according to the invention.

### DESCRIPTION OF THE PREFERRED EMBODIMENTS

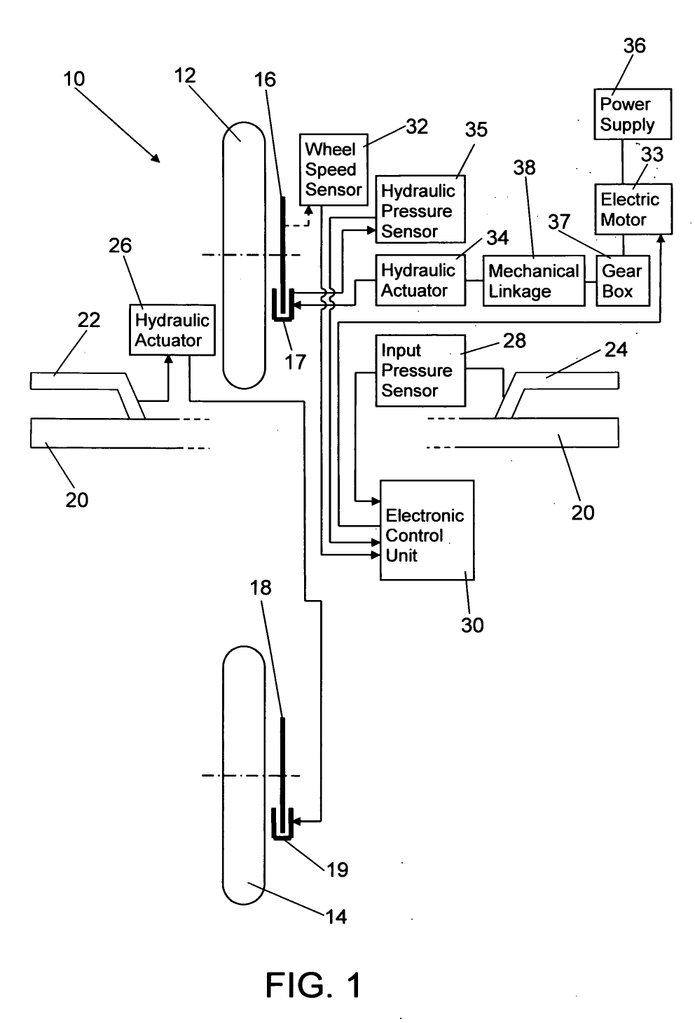

Referring now to the figures of the drawings in detail and first, particularly, to FIG. 1 thereof, there is shown a schematic overview of a bicycle 10 having an antilock brake system according to the invention. The bicycle 10 includes a front wheel 12 and a rear wheel 14. Attached to the front wheel 12 is a brake disc 16 and correspondingly a brake disc 18 is attached to the rear wheel 14. A brake caliper 17 is provided for transmitting a brake force to the front brake disc 16 and a further brake caliper 19 is provided for transmitting a brake force to the rear brake disc 18. The handlebar 20 of the bicycle 10 has two hand levers 22, 24. The hand lever 22 for the rear brake is mounted on the left side of the handlebar 20. The hand lever 24 for the front brake is mounted on the right side of the handlebar 20.

The rear brake of the bicycle 10 is configured as a conventional hydraulic bicycle brake. The handle lever 22 for the rear brake is operatively connected to a hydraulic actuator 26 which in turn is operatively connected to brake caliper 19 in order to transmit force from the handle lever 22 to the brake caliper 19.

The front brake of the bicycle 10 is configured as an electrically actuated disc brake system with wheel speed and acceleration sensing and an antilock braking control in accordance with the invention. The handle lever 24 is connected to an input pressure sensor 28 which detects a pressure or force that is generated when a rider pulls the handle lever 24. The input pressure sensor 28 thus measures the bicycle rider's desired braking force. This provides a natural feel for the braking action. The input pressure sensor 28 is connected to the electronic control unit 30 in order to provide sensor signals to the electronic control unit 30. A wheel speed sensor 32 is provided for the front wheel 12 in order to detect a rotational speed of the front wheel 12 of the bicycle 10. The wheel speed sensor 32 is connected to the electronic control unit 30 and provides sensor signals indicative of the rotational speed of the front wheel 12 to the electronic control unit 30. A hydraulic pressure sensor 35 is operatively connected to the brake caliper 17 on the brake disc 16 for the front wheel 12 in order to measure a hydraulic brake pressure in the brake caliper 17. The hydraulic pressure sensor 35 is connected to the electronic control unit 30 in order to provide a signal indicative of the hydraulic brake pressure to the electronic control unit 30.

The electronic control unit 30 is connected to an electric motor 33 in order to control the operation of the electric motor 33. The electric motor 33 drives a gearbox 37 which in turn operates a mechanical linkage 38 that is connected to a hydraulic actuator 34. The hydraulic actuator 34 is the hydraulic master cylinder for the front brake of the bicycle 10. The electric motor 33 and the gearbox 37 are selected such that the actuator has a bandwidth of substantially 10 Hz and a peak current draw of about 2 A. The electric motor 33, the gearbox 37, the mechanical linkage 38 and the hydraulic actuator 34 of the described embodiment are capable of responding quickly to modulate the pressure rapidly enough to effectively implement an ABS control loop. The hydraulic actuator 34 for the front brake is connected via a hydraulic line to the brake caliper 17 for the front brake disc 16 on the front wheel 12. The electric motor 33 is powered by a power supply 36 which is preferably a battery such as a rechargeable lithium polymer battery pack. The power supply 36 is also used to provide electric power to the electronic control unit 30. The front brake can in principle be configured such that in case of a loss of electric power, the pressure for the front brake is generated in a conventional manner by the rider actuating the hand lever 24.

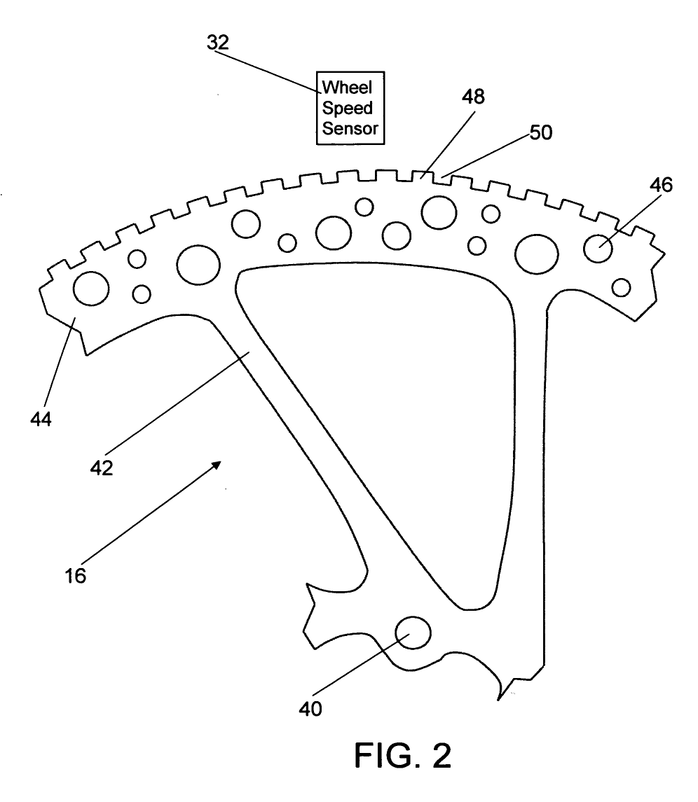

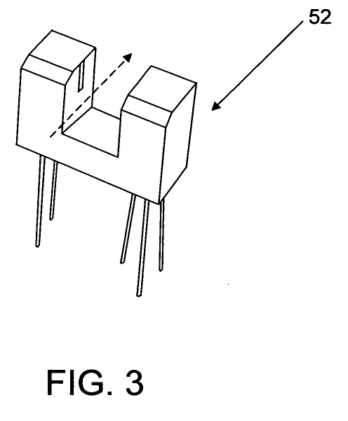

FIG. 2 shows a portion an exemplary embodiment of a brake disc 16 for an antilock brake system according to the invention. The brake disc 16 has holes 40 at its center region for securing the brake disc 16 to the hub of the front wheel 12. Spokes 42 extend from the center region of the brake disc 16 to the outer region 44 of the brake disc 16. The outer region 44 of the brake disc 16 has holes 46 and has tabs 48 along the perimeter of the brake disc 16. The tabs 48 are shaped as rectangular teeth and protrude in a radial direction away from the brake disc 16. The tabs 48 are spaced at substantially equal distances from one another. In the exemplary embodiment shown in FIG. 2, there are 100 tabs 48 along the perimeter of the brake disc 16 and the gaps 50 between the tabs 48 are substantially as wide as the tabs 48. A wheel speed sensor 32, which is only schematically shown in FIG. 2, is positioned adjacent to the brake disc 16 at its perimeter. The wheel speed sensor 32 can be embodied as an optical gate sensor 52 as illustrated in FIG. 3. The wheel speed sensor 32 can also be a Hall-effect sensor which is commonly used in antilock brake systems.

FIG. 3 is a diagrammatic perspective view of an optical gate sensor 52 for measuring a rotational speed of the front wheel 12 of a bicycle 10 according to the invention. The optical gate sensor 52 has an optical transmitter and an optical sensor opposite one another and spaced from one another such that the tabs 48 move into the optical path between the optical transmitter and the optical sensor when the front wheel 12 rotates. The movement path of the tabs 48 of the brake disc is indicated by a dashed line in FIG. 3. The tabs 48 interrupt the path of a light beam of the optical gate sensor 52 which allows a measurement of a rotational speed of the front wheel 12 of the bicycle and thus allows the electronic control unit 30 to calculate an acceleration. The tabs 48 are detected as they pass through the optical gate sensor 52, or correspondingly through or past the Hall-effect sensor. The time between detected tabs 48 is measured by a microcontroller and the speed and acceleration of the bicycle wheel are computed. The use of the tabs 48 allows a measurement of the rotational speed at a high frequency. Specifically, in the exemplary embodiment, the speed measurement is updated at a frequency of 100 times per wheel revolution. In accordance with a further embodiment, multiple sensors are used in order to increase the measurement frequency.

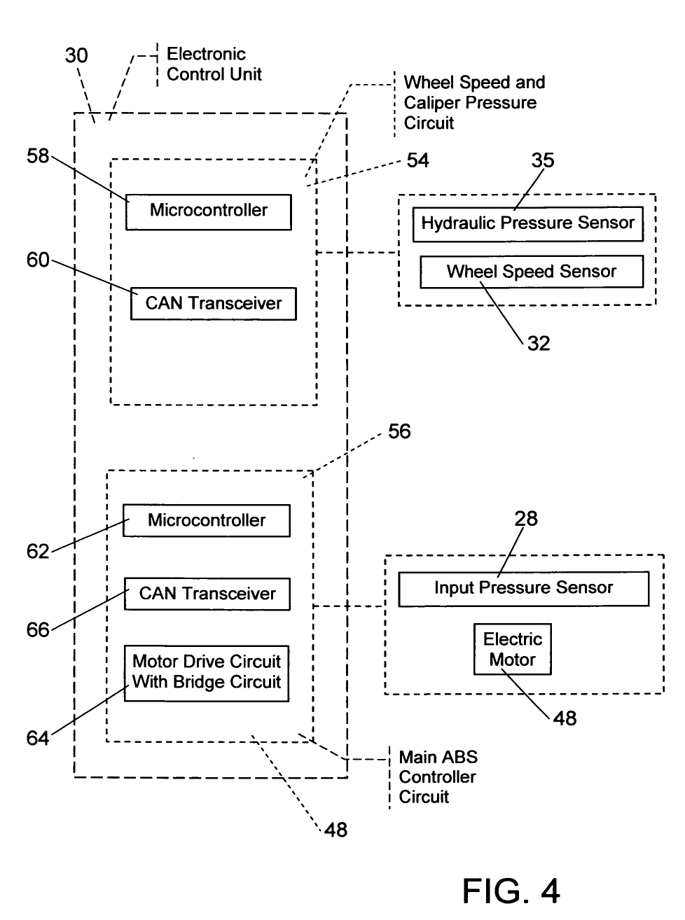

FIG. 4 is a schematic block diagram illustrating the main hardware components of the electronic control unit 30 and hardware components connected to the electronic control unit 30 in accordance with the invention. The electronic control unit 30 includes two main components, namely a wheel speed and caliper pressure circuit 54 and a main ABS (Antilock Brake System) controller circuit 56. The wheel speed and caliper pressure circuit 54 includes a microcontroller 58 for signal conditioning and for an analog to digital conversion of the brake caliper pressure signal provided by the hydraulic pressure sensor 35. The microcontroller 58 is also connected to the wheel speed sensor 32 for detecting the speed of the front wheel 12. The wheel speed and caliper pressure circuit 54 further includes a CAN (Controller Area Network) transceiver 60 in order to transfer signals between the hardware components, specifically to relay computation results and caliper pressure readings. The operation of the wheel speed and caliper pressure circuit 54 with respect to the speed measurement and acceleration computation is explained in more detail below.

The ABS controller circuit 56 includes a microcontroller 62 for signal conditioning and for an analog to digital conversion of the brake lever pressure signal, which is provided by the input pressure sensor 28. The ABS controller circuit 56 further includes a motor drive circuit 64 with an H-bridge and a CAN transceiver 66 for transferring signals between the components. The microcontroller 62 controls the electric motor 33 in accordance with the principles of a PID (proportional-integral-derivative) motor control loop in order to achieve the desired brake pressure. The method of controlling the electric motor 33 is described in more detail below. The microcontroller 62 uses an ABS control method in order to modulate the brake pressure for the brake caliper 17 of the brake disc 16. The wheel speed and caliper pressure circuit 54 and the main ABS controller circuit 56 are configured such that each is provided on a separate circuit board. As a result, the two circuit boards are small enough to be mounted in various mounting locations on the bicycle. The microcontrollers 58, 62 of the described embodiment are low-cost 8-bit microcontrollers such as the PIC18F248 microcontroller which is available from MICROCHIP TECHNOLOGY INC. The CAN transceivers 60, 66 of the described embodiment are for example MCP2551 CAN transceivers which are also available from MICROCHIP TECHNOLOGY INC. The motor drive circuit 64 may for example be embodied by an L6201 bridge driver circuit which is available from SGS-THOMSON MICROELECTRONICS.

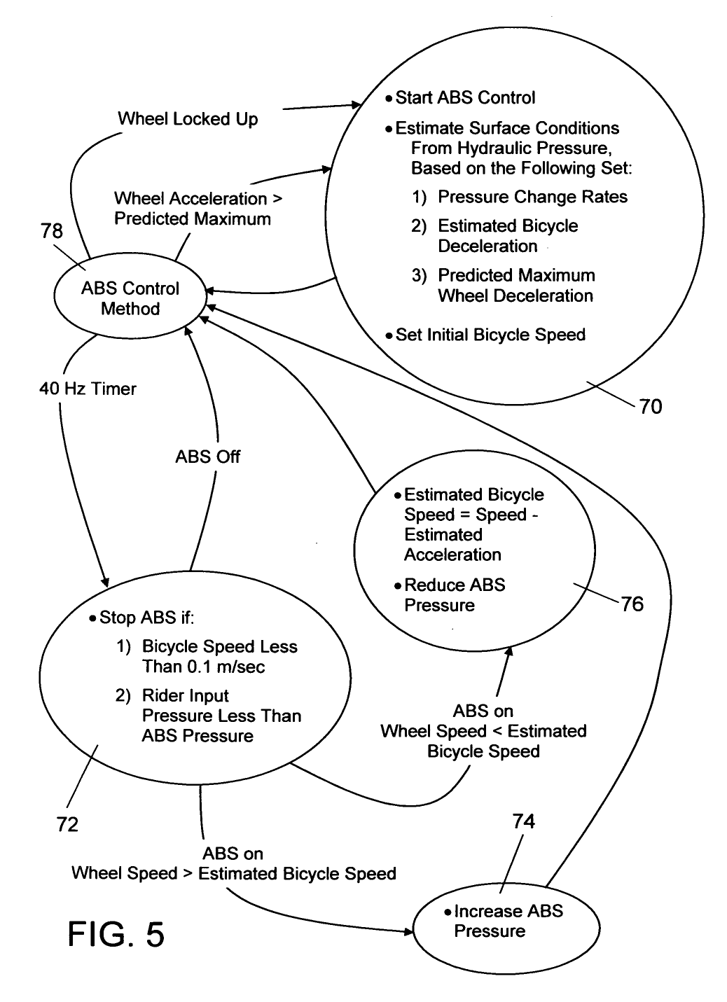

FIG. 5 is a state flow diagram illustrating the method of an antilock brake control in accordance with the invention. The circles and ovals in FIG. 5 illustrate various states of the antilock brake control. The arrows extending between respective two of the states indicate transitions between those states. The microcontroller 62 controls the braking of the front wheel 12 based on sensor inputs received by the microcontroller 62. During normal braking, i.e. without ABS intervention, the braking pressure is linearly mapped to the rider's desired braking pressure. Wheel lockup is predicted when the acceleration of the front wheel 12 is too great. The ABS control method then modulates the brake pressure to control the wheel slip and to prevent the front wheel 12 from locking up. The ABS control method estimates the braking surface conditions based on the braking force at which the front wheel 12 begins to lock up. From this estimate the ABS control method predicts the acceleration of the bicycle 10. The computed bicycle speed is then compared to the wheel speed in order to estimate wheel slip. By maintaining a desired level of wheel slip that is optimal for the surface condition, the ABS control method prevents a lockup of the wheel while braking with optimal force. The brake system according to the invention thus adapts elements of automotive ABS technology for the use with a bicycle and, as a result, the brake system is small and cost effective. The ABS control method according to the invention controls the braking pressure accurately with a feedback control loop and implements an adaptive ABS control method.

The above-described method is shown in the state flow diagram of FIG. 5. The state transition arrows indicate that when the wheel is locked up or when the wheel acceleration is greater than a predicted maximum value, which is indicative of excessive wheel slip or an impending wheel lockup, then a transition to the ABS control state 70 is performed. The ABS control starts and surface conditions, i.e. road surface conditions or track surface conditions, are estimated based on the hydraulic pressure measured by the hydraulic pressure sensor 35. Specifically, the surface conditions are estimated based on pressure change rates, the estimated bicycle deceleration, and a predicted maximum wheel deceleration. Furthermore, an initial bicycle speed is set in state 70.

As shown in state 72, the ABS control of the brake is stopped if either the bicycle speed is less than 0.1 meters per second or if the input pressure provided by the rider is less than the pressure set by the ABS control. In the state flow diagram of FIG. 5, a transition from state 72 to state 78 occurs. The decision to stop the ABS control is evaluated at a certain frequency at is indicated by the transition arrow labeled as 40 Hertz timer. If on the other hand, the ABS control is on and the wheel speed, which is measured by the wheel speed sensor 32, is greater than the estimated bicycle speed, then the ABS pressure for the brake caliper 17 is increased via the hydraulic actuator 34 and the electric motor 33 in order to slow down the front wheel 12 and ultimately to slow down the bicycle 10. In this case, a transition from state 74 to state 78 occurs.

In the case when the ABS control is on and the wheel speed of the front wheel 12 is less than the estimated bicycle speed, then the ABS pressure for the front brake caliper 17 is reduced. This step corresponds to a transition from state 72 to state 76 in FIG. 5. In state 76 the ABS pressure for the front wheel is reduced and the bicycle speed is estimated as the speed minus a speed based on an estimated acceleration.

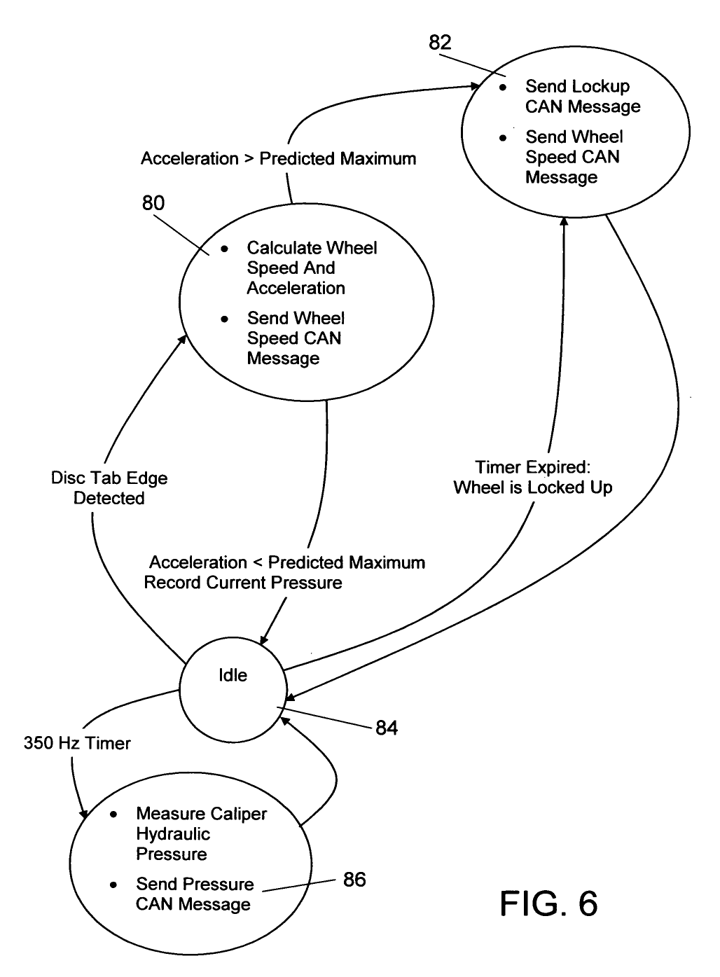

FIG. 6 is a state flow diagram illustrating the operation of the wheel speed and caliper pressure circuit 54 according to the invention. The wheel speed and caliper pressure circuit 54 performs a speed measurement and an acceleration computation wherein the CAN (controller area network) controller relays computation results and caliper pressure readings. The wheel speed of the front wheel 12 and the acceleration of the wheel are calculated in state 80 as is illustrated in FIG. 6. Further, a wheel speed CAN message is transmitted in state 80. If the acceleration is greater than a predicted maximum value, then a transition from state 80 to state 82 occurs and a lockup CAN message as well as a wheel speed CAN message is sent. On the other hand, if the acceleration is less than the predicted maximum, the current pressure for the caliper is recorded and a transition to the idle state 84 occurs. When an edge of a disc tab 48 is detected, the wheel speed and acceleration are again calculated and a corresponding wheel speed CAN message is sent (state 80). State 86 shows that the hydraulic pressure for the caliper is measured and a corresponding pressure CAN message is communicated. The transition between the idle state 84 and the pressure measuring state is characterized by a 350 Hertz timer. Also, a state transition between state 84 and the state 82 occurs in case of an expired timer which is related to the wheel being locked up.

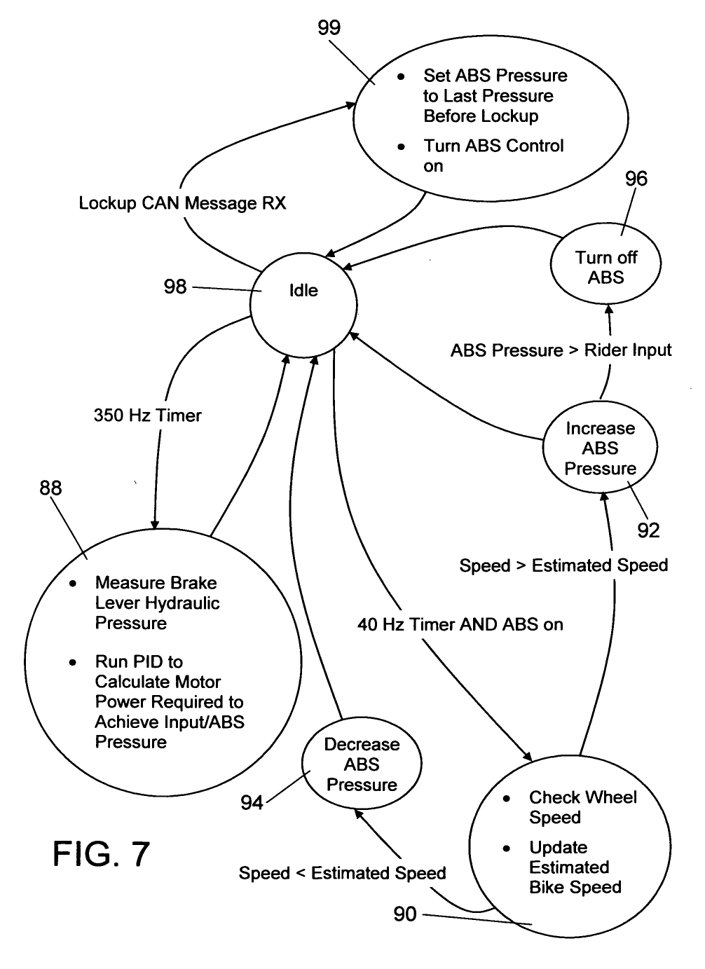

FIG. 7 is a state flow diagram illustrating the operation of the main ABS controller circuit 56 according to the invention. The main ABS controller circuit 56 is configured such that a PID (proportional-integral-derivative) motor control loop controls the electric motor 33 that drives the hydraulic actuator 34 in order to achieve the desired brake pressure. The brake pressure is modulated by using the ABS control method described above with reference to FIG. 5. The operation of the main ABS controller circuit 56 will be described with reference to the state flow diagram shown in FIG. 7. The brake lever hydraulic pressure is measured with a certain frequency and the above-mentioned PID control is used to calculate the power that the electric motor 33 has to produce in order to achieve a desired input pressure or, in case the ABS control is on, the ABS pressure as indicted by state 88. Further, the wheel speed is checked and the estimated speed of the bicycle is updated as is indicated by state 90. If the wheel speed is greater than the estimated bicycle speed, then the ABS pressure for the brake caliper 17 is increased as shown by the transition from state 90 to state 92. If the wheel speed is less than the estimated bicycle speed, then the ABS pressure for the brake caliper 17 is decreased as shown by the transition from state 90 to state 94. The ABS pressure control is turned off when the input pressure provided by the rider of the bicycle is smaller than the ABS pressure which corresponds to the transfer from state 92 to state 96. The control method can then provide a transition from state 96 to the idle state 98. A further state transition is shown in FIG. 7 in case a wheel lockup CAN message is transmitted. In this case, the ABS pressure is set to the last pressure before the wheel lockup occurred and the ABS control is turned on in order to provide a brake control without a wheel lockup as indicated by state 99 in FIG. 7.

What is claimed is:

1. A bicycle comprising:
a bicycle front wheel;
a brake disc connected to said bicycle front wheel;
a brake caliper configured to exert pressure on said brake disc;
a hydraulic actuator connected to said brake caliper and configured to provide a hydraulic pressure for said brake caliper;
an electric motor operatively connected to said hydraulic actuator and configured to drive said hydraulic actuator;
a power supply connected to said electric motor for providing electric power to said electric motor;
a wheel speed sensor configured to detect a rotational wheel speed;
a brake lever configured to provide an input pressure;
an input pressure sensor operatively connected to said brake lever and configured to measure the input pressure provided by said brake lever;
a hydraulic pressure sensor configured to measure the hydraulic pressure for said brake caliper;
an electronic control unit operatively connected to said input pressure sensor, said wheel speed sensor, said hydraulic pressure sensor and said electric motor;
said electronic control unit being configured to receive rotational wheel speed information from said wheel speed sensor, input pressure information from said input pressure sensor, and hydraulic pressure information from said hydraulic pressure sensor; and
said electronic control unit controlling said hydraulic actuator based on the rotational wheel speed information from said wheel speed sensor, the input pressure information from said input pressure sensor, and the hydraulic pressure information from said hydraulic pressure sensor, and said electronic control unit controlling said hydraulic actuator such that the hydraulic pressure for said brake caliper is adjusted to prevent said bicycle front wheel from locking up when input pressure is provided via said brake lever.

2. The bicycle according to claim 1, wherein said wheel speed sensor is a sensor element selected from the group consisting of a Hall sensor and an optical gate sensor.

3. The bicycle according to claim 1, wherein said wheel speed sensor includes multiple sensors configured such that a measurement frequency is increased in comparison to a wheel speed sensor including a single sensor.

4. The bicycle according to claim 1, wherein:
said brake disc has a perimeter and has tabs disposed at substantially equal distances from one another along said perimeter of said brake disc; and
said wheel speed sensor is an optical gate sensor defining an optical beam path, said wheel speed sensor is disposed at said perimeter of said brake disc such that said tabs move into and out of the optical beam path when said brake disc rotates.

5. The bicycle according to claim 4, wherein said tabs are substantially rectangular teeth disposed along said perimeter of said brake disc.

6. The bicycle according to claim 1, including:
a gearbox connected to said electric motor; and
a mechanical linkage connecting said gearbox to said hydraulic actuator such that said electric motor drives said hydraulic actuator via said gearbox and said mechanical linkage.

7. The bicycle according to claim 1, wherein:
said electric motor has a given motor power rating; and
said power supply is a battery with a given battery power rating such that said battery is capable of powering said electric motor.

8. The bicycle according to claim 1, wherein:
said electronic control unit includes a wheel speed and caliper pressure circuit and an antilock brake system controller circuit;
said wheel speed and caliper pressure circuit includes a microcontroller and a controller area network transceiver for transferring signals between said microcontroller and said wheel speed sensor and said hydraulic pressure sensor; and
said antilock brake system controller circuit includes a microcontroller, a motor drive circuit and a controller area network transceiver for transferring signals between said microcontroller and said input pressure senor and said motor drive circuit.

9. The bicycle according to claim 1, including a bicycle rear wheel, a rear brake disc connected to said bicycle rear wheel, a rear brake caliper configured to exert pressure on said rear brake disc, and a rear brake lever configured to provide a brake pressure for said rear brake caliper.

10. The bicycle according to claim 9, wherein said electronic control unit controls said hydraulic actuator without any wheel speed information related to said bicycle rear wheel.
